(19) United States
(12) Patent Application Publication
(10) Pub. No.: US 2008/0017315 A1
(43) Pub. Date: Jan. 24, 2008

(54) PLASMA PROCESSING APPARATUS

(75) Inventor: Yusuke Fukuchi, Atsugi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/777,865

(22) Filed: Jul. 13, 2007

(30) Foreign Application Priority Data
Jul. 24, 2006 (JP) 2006-200531

(51) Int. Cl. C23F 1/00; B05C 11/00

(52) U.S. Cl. 156/345.27; 118/712

(57) ABSTRACT

In a plasma processing apparatus including a plasma generating chamber, a plasma processing chamber which receives an objective substrate, and a conductance adjusting plate which allows a process gas to pass therethrough and which is provided to separate the above two chamber, the processing apparatus has a cooling unit configured to cool a portion supporting the conductance adjusting plate.

### BACKGROUND OF THE INVENTION

1. Field of the Invention

The present invention relates to a plasma processing apparatus which performs a plasma processing, such as etching, ashing, film formation, or modification, at a substrate surface.

2. Description of the Related Art

In recent years, a semiconductor manufacturing processing using plasma has been used for various processes, such as etching, ashing, and chemical vapor deposition (CVD).

As a related plasma processing apparatus, in Japanese Patent Laid-Open No. 7-263353, an apparatus has been proposed in which a generating chamber generating plasma and a processing chamber processing a substrate by the plasma generated in the generating chamber are separated from each other by a partition having a plurality of penetrated holes.

In the apparatus as described above, by the conductance based on the diameter, the length, and the number of the penetrated holes formed in the partition, a pressure difference is generated between the plasma generating chamber and the substrate processing chamber. By using this pressure difference, for example, in a CVD apparatus, a method is employed in which a starting material gas, which is introduced to the processing chamber side and is formed into a precursor, is prevented from flowing to the plasma generating chamber side.

In addition, in Japanese Patent Laid-Open No. 2005-142234, a technique has been proposed in which the flux of active species reaching an objective substrate during plasma processing is decreased as low as possible, and a subsequent processing is then performed.

That is, this processing is called an “upstream plasma processing” in which the objective substrate is placed upstream of a plasma generating region along a gas flow.

Also in the upstream plasma processing, as a method for further decreasing the flux of active species, a partition having a plurality of penetrated holes is provided between a plasma generating chamber and a plasma processing chamber which receives the objective substrate. By using the pressure difference generated by the conductance of this partition, back diffusion of active species is suppressed, and hence plasma processing at an extremely low flux can be performed.

However, in a plasma processing apparatus having a partition between a plasma generating region and a substrate processing region, ions and/or light having high energy emitted from plasma generated in the plasma generating region flows into the partition, and as a result, the temperature thereof may be increased at each processing in some cases.

Accordingly, since a process gas is heated and expanded by heat conducted from the gas holes of the partition, in accordance with an increase in temperature of the partition at each processing, the volume flow rate of the process gas passing through the gas holes of the partition is changed, and as a result, a desired pressure difference cannot be disadvantageously obtained.

According to the present invention, the increase in temperature of a conductance adjustment plate, that is, a partition provided between a plasma generating chamber and a processing chamber, at each processing is prevented, and there is provided a plasma processing apparatus which improves process reproducibility and process accuracy in plasma processing.

### SUMMARY OF THE INVENTION

A plasma processing apparatus according to an exemplary embodiment of the present invention includes a generating chamber configured to generate plasma; a processing chamber configured to receive an objective substrate; and a conductance adjusting plate which allows a process gas to pass therethrough and which is provided so as to separate the generating chamber from the processing chamber.

In the above plasma processing apparatus, the generating chamber and the processing chamber form a processing container, and the processing container has a cooling unit configured to cool a portion of the processing container supporting the conductance adjusting plate to maintain the conductance adjusting plate at a predetermined temperature.

In the plasma processing apparatus according to the present invention, the unit configured to maintain the conductance adjusting plate at a predetermined temperature may be a cooling unit configured to circulate a cooled cooling medium in the conductance adjusting plate.

In the plasma processing apparatus according to the present invention, the conductance adjusting plate may be formed of silicon.

In the plasma processing apparatus according to the present invention, the conductance adjusting plate may have a plurality of penetrated holes which penetrate therethrough so that the generating chamber and the processing chamber communicate with each other.

In the plasma processing apparatus according to the present invention, the process gas used for the plasma processing can be supplied from the side of the generating chamber in which the plasma is generated, passes through the conductance adjusting plate, flows into the processing chamber in which the objective substrate is received, processes the surface of the objective substrate, and is discharged outside the apparatus.

In the plasma processing apparatus according to the present invention, the process gas used for the plasma processing may be supplied from the side of the processing chamber in which the objective substrate is received, passes through the conductance adjusting plate, flows into the generating chamber in which the plasma is generated, and is discharged outside the apparatus.

In the plasma processing apparatus according to the present invention, the plasma processing may be one of etching, ashing, modification, and thin-film deposition, which is performed at the surface of the objective substrate.

In the plasma processing apparatus according to the present invention, the modification may be an oxidation or a nitridation processing.

Further features and aspects of the present invention will become apparent from the following description of exemplary embodiments with reference to the attached drawings.

### BRIEF DESCRIPTION OF THE DRAWINGS

FIG. 1 is a cross-sectional view of a schematic structure of an example plasma processing apparatus of a first exemplary embodiment according to the present invention.

FIG. 2 is a cross-sectional view of a schematic structure of an example plasma processing apparatus of other exemplary embodiments (embodiments 2 through 4) according to the present invention.

FIG. 3 is a graph showing the changes in temperature and pressure by discharge-rest cycles, which is obtained when a silicon-made conductance adjusting plate is used in a second exemplary embodiment according to the present invention.

FIG. 4 is a graph showing the changes in temperature and pressure by discharge-rest cycles, which is obtained when a quartz-made conductance adjusting plate is used in the second exemplary embodiment according to the present invention.

FIG. 5 is a cross-sectional view of a schematic structure of an example plasma processing apparatus used in other exemplary embodiments (embodiments 5 and 6) according to the present invention.

### DESCRIPTION OF THE EMBODIMENTS OF THE INVENTION

Hereinafter, with reference to the drawings, the present invention will be described based on the embodiments.

### First Exemplary Embodiment

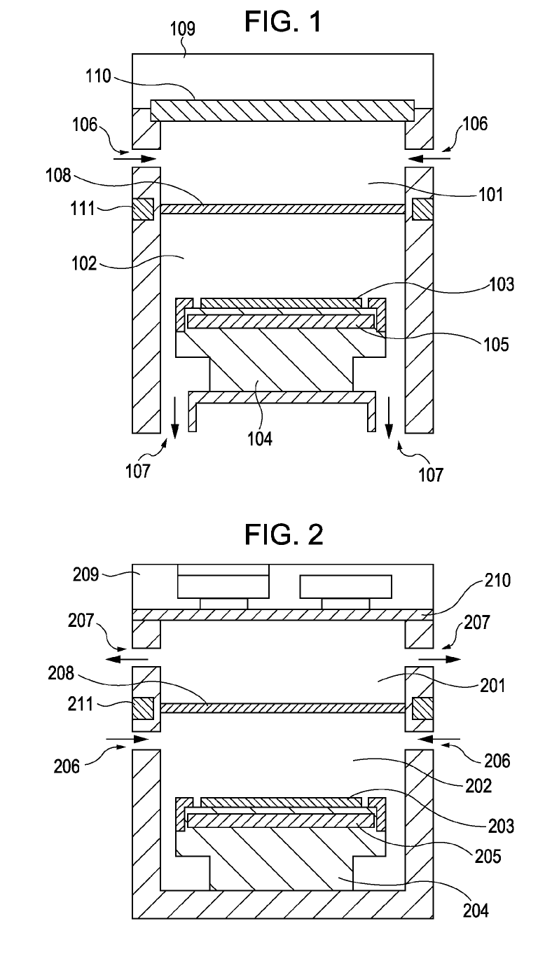

With reference to FIG. 1, a microwave plasma processing apparatus (hereinafter referred to as a “plasma processing apparatus”) of a first exemplary embodiment according to the present invention will be described in detail. In particular, FIG. 1 is a cross-sectional view of a schematic structure of the plasma processing apparatus of the first embodiment according to the present invention.

As shown in FIG. 1, the plasma processing apparatus has a plasma generating chamber 101, a plasma processing chamber 102, an objective substrate 103, a support member 104, a temperature control portion 105, a gas inlet 106, and an exhaust outlet 107.

In addition, the plasma processing apparatus has a conductance adjusting plate 108, a microwave supply unit 109, a microwave transmitting unit 110, and a cooling unit 111, and performs plasma processing for the objective substrate 103.

As the plasma processing, for example, there may be mentioned an etching, an ashing, a modification, or a thin-film deposition processing, which is performed at the surface of the objective substrate 103. In particular, as the modification processing, for example, an oxidation or a nitridation processing may be mentioned.

A microwave generator (not shown) of the plasma processing apparatus is formed, for example, of a magnetron and generates, for example, a microwave having a frequency of 2.45 GHz. However, in the present invention, a microwave frequency may be optionally selected from the range of 0.8 to 20 GHz.

Subsequently, the microwave is converted into a TM mode, TE mode, or the like by a mode converter (not shown) and is then propagated in a waveguide tube. Along a microwave waveguide path, for example, an isolator and/or an impedance matching device is provided.

The isolator prevents a reflected microwave from returning to the microwave generator and absorbs the reflected microwave as described above.

The impedance matching device has a power meter to detect the intensity and the phase of a traveling wave supplied from the microwave generator to a load and those of a reflected wave which is reflected by the load and is to return to the microwave generator.

The impedance matching device has a function of matching a microwave at the microwave generator and that at the load side through the power meter, and although being not shown in detail, the impedance matching device is composed of a 4E tuner, an EH tuner, a stub tuner, or the like.

On the other hand, the plasma processing chamber 102 is a vacuum processing container which receives the objective substrate 103 on a stage on the temperature control portion 105 and which performs plasma processing for the objective substrate 103 under a vacuum or a reduced-pressure condition.

In FIG. 1, a gate valve and the like used for transferring the objective substrate 103 from and to a load lock chamber (not shown) are omitted in the figure. The objective substrate 103 may be any one of a semiconductor, an electrical conductive, and an electrical insulating substrate.

For the electrical conductive substrate, for example, there may be used a metal, such as Fe, Ni, Cr, Al, Mo, Au, Nb, Ta, V, Ti, Pt, or Pb, or an alloy thereof, such as brass or stainless steel.

For the electrical insulating substrate, first, SiO₂-based compounds, such as quartz and various glasses, and inorganic compounds, such as Si₃O₄, NaCl, KCl, LiF, CaF₂, BaF₂, Al₂O₃, AlN, and MgO, may be used. For the electrical insulating substrate, secondly, an organic film, window, or the like which is made, for example, of polyethylene, polyester, polycarbonate, cellulose acetate, polypropylene, poly(vinyl chloride), poly(vinylidene chloride), polystyrene, polyamide, or polyimide may be used.

The objective substrate 103 is placed on the stage on the support member 104; however, whenever necessary, the support member 104 may be formed so that the height thereof is adjustable. That is, the support member 104 is placed in the plasma processing chamber 102 and supports the objective substrate 103.

The temperature control portion 105 is formed of a heater or the like and controls the temperature so as to be suitable for processing performed, for example, in the range of 200 to 400° C. Although being not shown in detail in the figure, for example, the temperature control portion 105 has a thermometer measuring the temperature of the support member 104 and a control part controlling, for example, the process gas and/or the objective substrate 103 at a predetermined temperature based on the temperature measured by the thermometer. The control part of the temperature control portion 105 controls, for example, the process gas and/or the objective substrate 103 at a predetermined temperature, for example, by controlling electricity supplied from an electrical source (not shown) to a heater wire used as a heating source.

The gas inlet 106 is provided in the wall of the plasma generating chamber 101 and supplies a plasma process gas into the plasma generating chamber 101. The gas inlet 106 is a part of a gas supply unit. Although being not shown in detail in the figure, the gas supply unit has gas supply sources, valves, mass flow controllers, and gas lines connecting therebetween, and supplies a process gas and a discharge gas in order to obtain predetermined plasma by microwave excitation.

To the process gas and/or the discharge gas, a rare gas, such as Xe, Ar, or He, may be added at least in ignition in order to achieve rapid plasma ignition. Since a rare gas has no reactivity, there have no adverse influences on the objective substrate 103, and in addition, since a rare gas is easily ionized, a plasma igniting speed can be increased when a microwave is supplied. In addition, as a gas used for forming a thin film on the substrate by a CVD method, a commonly known gas can be used.

For example, as a starting material gas forming a silicon-based semiconductor thin film, such as an amorphous Si (a-Si), a polycrystalline Si, or a SiC film, a material in a gas state at normal temperature and pressure or a material which can be easily gasified is preferable.

As one example, inorganic silanes, such as SiH₄ and Si₂H₆, may first be mentioned. Secondly, for example, organic silanes, such as tetraethylsilane (TES), tetramethylsilane (TMS), dimethylsilane (DMS), dimethyldifluorosilane (DMDFS), and dimethyldichlorosilane (DMDCS), may be mentioned.

In addition, for example, there may also be mentioned halogenated silanes, such as SiF₄, Si₂F₆, Si₃F₈, SiHF₃, SiH₂F₂, SiCl₄, Si₂Cl₆, SiHCl₃, SiH₂Cl₂, SiH₃Cl, and SiCl₂F₂. In addition, as an additional gas or a carrier gas which may be mixed and supplied with the Si starting material gas in this case, for example, H₂, He, Ne, Ar, Kr, Xe, or Rn may be mentioned.

For example, as a starting material gas forming a Si compound-based thin film composed, for example, of Si₃N₄ or SiO₂, a material in a gas state at normal temperature and pressure or a material which can be easily gasified is preferable as is the case described above.

As one example, first, inorganic silanes, such as SiH₄ and Si₂H₆, may be mentioned. Secondly, for example, organic silanes, such as tetraethoxysilane (TEOS), tetramethoxysilane (TMOS), octamethylcyclotetrasilane (OMCTS), dimethyldifluorosilane (DMDFS), and dimethyldichlorosilane (DMDCS), may be mentioned.

Thirdly, for example, halogenated silanes, such as SiF₄, Si₂F₆, Si₃F₈, SiHF₃, SiH₂F₂, SiCl₄, Si₂Cl₆, SiHCl₃, SiH₂Cl₂, SiH₃Cl, and SiCl₂F₂, may be mentioned. In addition, as a nitrogen source gas or an oxygen source gas, which is simultaneously supplied in this case, for example, N₂, NH₃, N₂H₄, hexamethyldisilazane (HMDS), O₂, O₃, H₂O, NO, N₂O, and NO₂ may be mentioned.

For example, as a starting material forming a metal thin film of Al, W, Mo, Ti, Ta, or the like, an organic metal, such as trimethylaluminum (TMAl), triethylaluminum (TEAl), or triisobutylaluminum (TIBAl), may first be mentioned by way of example.

In addition, for example, an organic metal, such as dimethylaluminum hydride (DMAlH), tungsten carbonyl (W(CO)₆), molybdenum carbonyl (Mo(CO)₆), trimethylgallium (TMGa), or triethylgallium (TEGa), may secondly be mentioned. Furthermore, thirdly, for example, a halogenated metal, such as AlCl₃, WF₆, TiCl₃, or TaCl₅, may be mentioned. In addition, as an additional gas or a carrier gas, which may be mixed and supplied with the Si starting material in this case, for example, H₂, He, Ne, Ar, Kr, Xe, or Rn may be mentioned.

For example, as a starting material forming a metal compound thin film of Al₂O₃, AlN, Ta2O₅, TiO₂, TiN, WO₃, or the like, an organic metal, such as trimethylaluminum (TMAl) or triethylaluminum (TEAl), may first be mentioned by way of example.

Secondly, for example, an organic metal, such as triisobutylaluminum (TIBAl), dimethylaluminum hydride (DMAlH), or tungsten carbonyl (W(CO)₆), may be mentioned. Thirdly, for example, an organic metal, such as molybdenum carbonyl (Mo(CO)₆), trimethylgallium (TMGa), or triethylgallium (TEGa), or a halogenated metal, such as AlCl₃, WF₆, TiCl₃, or TaCl₅, may be mentioned.

In addition, as an oxygen source gas or a nitrogen source gas, which is simultaneously supplied in this case, for example, O₂, O₃, H₂O, NO, N₂O, NO₂, N₂, NH₃, N₂H₄, or hexamethyldisilazane (HMDS), may be mentioned.

For example, as an etching gas etching a substrate surface, there may be mentioned F₂, CF₄, CH₂F₂, C₂F₆, C₃F₈, C₄F₈, CF₂Cl₂, SF₆, NF₃, Cl₂, CCl₄, CH₂Cl₂, or C₂Cl₆ by way of example. As an ashing gas removing an organic component, such as a photoresist, on a substrate surface by ashing, for example, O₂, O₃, H₂O, NO, N₂O, NO₂, or H₂ may be mentioned. When the surface of the objective substrate 103 is modified, in accordance with a gas appropriately selected for this purpose, for example, Si, Al, Ti, Zn, or Ta may be used for the substrate of a surface layer thereof in some cases.

In this case, for example, an oxidation or a nitridation processing can be performed for the substrate or the surface layer, and in addition, a doping processing using B, As, P, or the like can also be performed.

Furthermore, plasma processing used in Embodiment 1 of the present invention can also be applied to a cleaning method. In this case, the plasma processing can also be used, for example, for cleaning an oxide, an organic material, and/or a heavy metal.

As an oxidizing gas performing a surface oxidation processing for the objective substrate 103, for example, O₂, O₃, H₂O, NO, N₂O, or NO₂ may be mentioned. In addition, as a nitriding gas performing a surface nitridation processing for the objective substrate 103, for example, N₂, NH₃, N₂H₄, or hexamethyldisilazane (HMDS) may be mentioned. As a cleaning/ashing gas used for cleaning an organic material on the objective substrate 103 or for removing an organic component, such as a photoresist, thereon by ashing, for example, O₂, O₃, H₂O, NO, N₂O, NO₂, or H₂ may be mentioned. In addition, as a cleaning gas used for cleaning an inorganic material on the objective substrate 103, for example, F₂, CF₄, CH₂F₂, C₂F₆, C₄F₈, CF₂Cl₂, SF₆, or NF₃ may be mentioned.

In addition, the exhaust outlet 107 is provided at a lower circumferential portion of the plasma processing chamber 102 and forms a pressure regulating mechanism together with a pressure regulating valve, a pressure gauge, a vacuum pump, and a control portion (not shown). That is, while the vacuum pump is operated, the control portion (not shown) controls so that the pressure gauge detecting a pressure of the plasma processing chamber 102 indicates a predetermined value.

In particular, the control portion performs pressure regulation by controlling the pressure regulating valve (such as a gate valve provided with a pressure regulating function manufactured by VAT SKK VACUUM LTD. or an exhaust slot valve manufactured by MKS Instrument Inc.) which regulates the pressure of the plasma processing chamber 102 by the degree of opening of the valve.

As a result, through the exhaust outlet 107, the inside pressure of the plasma processing chamber 102 is controlled to a pressure suitable for plasma processing. The pressure is preferably in the range of 13 mPa to 1,330 Pa and more preferably in the range of 665 mPa to 665 Pa.

The vacuum pump is, for example, a dry pump or a turbo molecular pump (TMP) and is connected to the plasma processing chamber 102 through a pressure regulating valve such as a conductance valve (not shown).

The conductance adjusting plate 108 is a partition having a plurality of penetrated holes and is provided so as to separate the plasma processing chamber 102 from the plasma generating chamber 101. In addition, in the wall of the processing container supporting the conductance adjusting plate 108, the cooling unit 111 is provided.

The conductance of a process gas passing through the penetrated holes of the conductance adjusting plate 108 can be adjusted to be a desired conductance by changing the diameter, the length, and the number of the penetrated holes.

The process gas supplied in the plasma generating chamber 101 is transported to the plasma processing chamber 102 via the conductance adjusting plate 108 and is then discharged outside the plasma processing chamber 102 via the exhaust outlet 107.

In this step, by the conductance of the conductance adjusting plate 108, the pressure difference is generated between the plasma generating chamber 101 and the plasma processing chamber 102. This pressure difference has a predetermined value by the flow rate of the supplied process gas and the exhaust velocity at which the inside of the plasma processing chamber 102 is exhausted.

During plasma processing, high energy ions in plasma and high energy light emitted therefrom flow into the conductance adjusting plate 108 and are converted into heat. Accordingly, for example, when a processing apparatus has not a unit configured to maintain the conductance adjusting plate 108 at a predetermined temperature as in the past, the temperature of the conductance adjusting plate 108 is increased.

Hence, when the process gas passes through the conductance adjusting plate 108, since it is heated by the conductance adjusting plate 108, the volume flow rate of the process gas is changed, and as a result, a pressure difference, which is different from that to be naturally obtained under original conditions, is generated between the plasma generating chamber 101 and the plasma processing chamber 102.

That is, since the process gas is heated by the conductance adjusting plate 108, and the volume flow rate of the process gas is changed, the pressure difference, which is different from that to be naturally obtained under original conditions, is generated between the plasma generating chamber 101 and the plasma processing chamber 102.

However, in the first exemplary embodiment of the present invention, by the unit configured to maintain the conductance adjusting plate 108 at a predetermined temperature, even when heat emitted from plasma flows into the conductance adjusting plate 108, the temperature thereof is maintained constant.

Hence, when the process gas passes through the conductance adjusting plate 108, the volume flow rate of the process gas is not changed, and as a result, a desired pressure difference can be obtained between the plasma generating chamber 101 and the plasma processing chamber 102.

In order to maintain the conductance adjusting plate 108 at a predetermined temperature, first, the conductance adjusting plate 108 is formed of a material having a thermal conductivity of at least 30 W/m·K.

As the unit configured to maintain the conductance adjusting plate 108 at a predetermined temperature, secondly, the cooling unit 111 is provided which cools the wall of the processing container supporting the conductance adjusting plate 108 (wall of the processing container located between the plasma generating chamber 101 and the plasma processing chamber 102) to a predetermined temperature.

The cooling unit 111 is a unit to maintain the conductance adjusting plate 108 at a predetermined temperature; however, since the predetermined temperature is a temperature suitable for plasma processing, an optimum temperature is appropriately selected for each plasma processing.

When the conductance adjusting plate 108 is formed from the material having a high thermal conductivity, since heat transmitted to the conductance adjusting plate 108 from plasma is rapidly conducted to the wall of the processing container, the conductance adjusting plate 108 can be cooled to a predetermined temperature by the cooling unit 111.

Accordingly, the increase in temperature of the conductance adjusting plate 108 caused by accumulated heat can be prevented.

Incidentally, as the material having a thermal conductivity of at least 30 W/m·K, for example, when it is necessary to perform an oxidation processing or a nitridation processing for a gate insulating film of a semiconductor device, which requires a significantly low metal contamination level, silicon is preferably selected.

In addition, the silicon may be any one of single crystal, amorphous, and polycrystalline silicon, and intrinsic semiconductor silicon or conductive silicon containing a dopant such as As, P, or B may also be used.

In addition, besides silicon, as a material used for processing, such as etching of a metal wire, in which metal contamination may not cause any serious problem, for example, a metal, such as Ta, Fe, Ni, Zn, Mo, W, Al, Cu, or Ag, or an alloy thereof, such as brass, may be mentioned. In addition, as the material having a thermal conductivity of at least 30 W/m·K, for example, a ceramic material, such as SiC or AlN, may also be used.

As the cooling unit 111 configured to maintain the conductance adjusting plate 108 at a predetermined temperature, although being not shown in detail in the figure, as another example, a cooling mechanism may also be mentioned which circulates a cooling medium cooled to a predetermined temperature in the conductance adjusting plate 108.

In this case, the conductance adjusting plate 108 may be formed using a material having a relatively low thermal conductivity, such as quartz or Si₃N₄; however, when a material having a higher thermal conductivity is used, the conductance adjusting plate 108 can be more easily maintained at a predetermined temperature.

However, as the cooling unit, in addition to those described above, for example, a heat pipe, a Peltier element, or a blower mechanism sending a cold or a natural wind may also be mentioned, and hence any optional structure may be used.

The microwave transmitting unit 110 transmits a microwave supplied from the microwave generator to the plasma generating chamber 101 and, in addition, functions as a partition of the plasma generating chamber 101. The microwave supply unit 109 has a slotted planar structure and has a function of supplying a microwave into the plasma generating chamber 101 via the microwave transmitting unit 110.

However, as the microwave supply unit 109, as long as a plane microwave is supplied, any structure, such as a slotted endless circular waveguide or a coaxial introducing plane multi-slot antenna, may be used.

As a material of the planar microwave supply unit 109 used for the plasma processing apparatus (microwave plasma processing apparatus) of Embodiment 1 of the present invention, for example, Al, Cu, or Ag/Cu plated stainless steel, having a high conductivity, is most preferable.

For example, when the slotted planar microwave supply unit 109 is a slotted endless circular waveguide, a cooling water channel and a slot antenna are provided. The slot antenna is a metal disc having, for example, radial slots, circumferential slots, a large number of concentric or spiral slots having an approximately T shape, or four pairs of V-shaped slots.

In order to perform uniform processing over the entire surface of the objective substrate 103, it is important to supply active species with good in-plane uniformity over the objective substrate 103. Since the slot antenna has at least one slot, plasma can be generated over a large area, and hence the plasma intensity and uniformity can be easily controlled.

Next, an operation example of the plasma processing apparatus of with respect to the first exemplary embodiment will now herein be described. In this embodiment, a down-flow processing method is used in which the process gas is supplied from the plasma generating chamber 101 side, is then fed into the plasma processing chamber 102 after passing through the conductance adjusting plate 108, and is then discharged after processing the surface of the objective substrate 103.

In particular, first, the plasma generating chamber 101 and the plasma processing chamber 102 are exhausted by an exhaust unit (not shown) through the exhaust outlet 107. Subsequently, the process gas is supplied at a predetermined flow rate into the plasma generating chamber 101 from the gas inlet 106, and a conductance valve provided for the exhaust unit (not shown) is adjusted, so that the inside of the plasma processing chamber 102 is maintained at a predetermined pressure.

A microwave is supplied to the plasma generating chamber 101 from the microwave generator through the microwave supply unit 109 and the microwave transmitting unit 110, so that plasma is generated in the plasma generating chamber 101.

Active species in plasma are supplied into the plasma processing chamber 102 together with the supplied gas after passing through the conductance adjusting plate 108 and reaches the surface of the objective substrate 103, followed by processing thereof.

During the surface processing by plasma, high energy ions in plasma and high energy light emitted therefrom flow into the conductance adjusting plate 108 and are converted into heat.

However, by the cooling unit 111 to maintain the conductance adjusting plate 108 at a predetermined temperature, the temperature thereof is not unnecessarily increased, and the predetermined temperature (temperature suitable for plasma processing) is maintained.

Hence, when passing through the conductance adjusting plate 108, the process gas is not expanded by heat, and a predetermined pressure difference is generated between the plasma generating chamber 101 and the plasma processing chamber 102; hence, a stable plasma processing can be performed.

In the first embodiment of the present invention, the down-flow processing method is described by way of example in which the process gas is supplied from the gas inlet provided in the plasma generating chamber 101, and active species plasmanized therein are then fed together with the process gas into the plasma processing chamber 102 located downstream along the gas flow path. However, with respect to the first embodiment of the present invention, a processing method may also be used in which the gas inlet 106 is provided at the plasma processing chamber 102 side, the process gas is supplied in the plasma processing chamber 102 in which the support member 104 is placed, and the gas flow is then introduced in the plasma generating chamber 101.

That is, a processing method may be used in which the process gas is supplied into the plasma processing chamber 102 to introduce the gas flow into the plasma generating chamber 101 and is then discharged from the exhaust outlet 107 provided therein.

Furthermore, in the first embodiment, a plasma exciting unit using a microwave is used as a plasma source; however, of course, an optional plasma exciting unit generating, for example, capacitive coupled plasma (CCP), inductively coupled plasma (ICP), helicon plasma, or electron cyclotron resonance (ECR) plasma, may also be used.

In the plasma processing apparatus of Embodiment 1 according to the present invention, the conductance adjusting plate 108 is formed of a material (such as silicon) having a thermal conductivity of at least 30 W/m·K, and the cooling unit 111 configured to maintain a predetermined temperature is provided.

Hence, an unnecessary increase in temperature of the conductance adjusting plate 108 at each plasma processing is prevented, the expansion of the conductance adjusting plate 108 is prevented, and as a result, the change in volume flow rate of the process gas passing through the holes provided in the conductance adjusting plate 108 can be prevented.

Accordingly, a desired pressure difference between the plasma generating chamber 101 and the plasma processing chamber 102 can be obtained, and hence process reproducibility and process accuracy in plasma processing can be improved.

### Second Exemplary Embodiment

Next, a second exemplary embodiment of the present invention will be described. FIG. 2 is a cross-sectional view showing a schematic structure of a plasma processing apparatus of the second embodiment according to the present invention

As shown in FIG. 2, the plasma processing apparatus has a plasma generating chamber 201, a plasma processing chamber 202, an objective substrate 203, a support member 204, a temperature control portion 205, a gas inlet 206, and an exhaust outlet 207.

In addition, the plasma processing apparatus has a conductance adjusting plate 208, a microwave supply unit 209, a microwave transmitting unit 210, and a cooling unit 211, and performs plasma processing for the objective substrate 203.

Furthermore, although being not shown in detail in the figure, in the plasma processing apparatus, the microwave generator, the isolator, the impedance matching device, and the like, which are described in Embodiment 1, are provided.

Also in this embodiment, as the plasma processing, for example, there may be mentioned an etching, an ashing, a modification, or a thin-film deposition processing, which is performed at the surface of the objective substrate 203. In particular, as the modification processing, for example, an oxidation or a nitridation processing may be mentioned.

In addition, the plasma processing chamber 202 is a vacuum processing container which receives the objective substrate 203 on a stage on the temperature control portion 205 and which performs plasma processing for the objective substrate 203 under a vacuum or a reduced-pressure condition.

In the wall of the plasma processing chamber 202, the gas inlet 206 is provided. The gas inlet 206 is a part of a gas supply unit supplying a plasma process gas to the plasma processing chamber 202.

Although being not shown in detail in the figure, the gas supply unit has gas supply sources, valves, mass flow controllers, and gas lines connecting therebetween, and supplies a process gas and a discharge gas in order to obtain predetermined plasma by microwave excitation.

In FIG. 2, a gate valve and the like used for transferring the objective substrate 203 from and to a load lock chamber (not shown) are omitted in the figure. The objective substrate 203 may be any one of a semiconductor, an electrical conductive, and an electrical insulating substrate.

The objective substrate 203 is placed on the stage on the support member 204; however, whenever necessary, the support member 204 may be formed so that the height thereof is adjustable. That is, the support member 204 is placed in the plasma processing chamber 202 and supports the objective substrate 203.

The temperature control portion 205 is formed of a heater or the like and controls the temperature so as to be suitable for processing performed, for example, in the range of 200 to 400° C.

Although being not shown in detail in the figure, for example, the temperature control portion 205 has a thermometer measuring the temperature of the support member 204 and a control part controlling, for example, the process gas and/or the objective substrate 203 at a predetermined temperature based on the temperature measured by the thermometer.

The control part of the temperature control portion 205 controls, for example, the process gas and/or the objective substrate 203 at a predetermined temperature, for example, by controlling electricity supplied from an electrical source (not shown) to a heater wire used as a heating source.

In addition, the exhaust outlet 207 is provided in the plasma generating chamber 201, and although being not shown in detail in the figure, the exhaust outlet 207 forms a pressure regulating mechanism together with a pressure regulating valve, a pressure gauge, a vacuum pump, and a control portion (not shown).

The control portion of the pressure regulating mechanism performs pressure regulation by controlling the pressure regulating valve (such as a gate valve provided with a pressure regulating function manufactured by VAT SKK VACUUM LTD. or an exhaust slot valve manufactured by MKS Instrument Inc.) which regulates the pressure of the plasma processing chamber 202 by the degree of opening of the valve.

As a result, through the exhaust outlet 207, the inside pressure of the plasma processing chamber 202 is controlled to a pressure suitable for plasma processing. The pressure is preferably in the range of 13 mPa to 1,330 Pa and more preferably in the range of 665 mPa to 665 Pa.

The conductance adjusting plate 208 is formed of a partition having a plurality of penetrated holes and is provided so as to separate the plasma processing chamber 202 from the plasma generating chamber 201. For the conductance adjusting plate 208, a polycrystalline silicon plate having a diameter of 260 mm, a thickness of 5 mm, and a thermal conductivity of 140 W/m·K is used. In this plate, 229 holes having a diameter of 1 mm are disposed in a lattice matrix with regular intervals of 10 mm.

In addition, in order to maintain the wall of the processing container and the vicinity thereof, which support the conductance adjusting plate 208, at room temperature, a water cooling pipe used as the cooling unit 211 is embedded in the wall of the processing container, and a water cooling pipe (cooling unit) is embedded also in the conductance adjusting plate 208.

The conductance of the process gas passing through the penetrated holes of the conductance adjusting plate 208 can be adjusted to be a desired conductance by changing the diameter, the length, and the number of the penetrated holes.

The process gas supplied in the plasma processing chamber 202 is transported to the plasma generating chamber 201 after passing through the conductance adjusting plate 208 and is then discharged outside the plasma generating chamber 201 through the exhaust outlet 207.

In this step, by the conductance of the conductance adjusting plate 208, the pressure difference is generated between the plasma generating chamber 201 and the plasma processing chamber 202.

This pressure difference has a predetermined value by the flow rate of the supplied process gas and the exhaust velocity at which the inside of the plasma generating chamber 201 is exhausted.

In addition, the microwave transmitting unit 210 transmits a microwave supplied from the microwave generator to the plasma generating chamber 201 and, in addition, functions as a partition of the plasma generating chamber 201. The microwave supply unit 209 has, for example, a slotted planar structure and has a function of supplying a microwave into the plasma generating chamber 201 via the microwave transmitting unit 210.

Next, the plasma processing apparatus of the second embodiment according to the present invention is briefly described; however, since the remaining structure and the related matters (such as gases used in the embodiment) is the similar to the first embodiment, detailed description thereof is omitted.

In the second embodiment according to the present invention, the plasma processing apparatus shown in FIG. 2 was used, and the change in temperature of the conductance adjusting plate 208 and the change in pressure difference between the plasma generating chamber 201 and the plasma processing chamber 202 were measured.

In particular, first, the inside of the plasma generating chamber 201 and that of the plasma processing chamber 202 were exhausted from the exhaust outlet 207 which was provided in the wall of the plasma generating chamber 201 via an exhaust system (not shown) to a pressure of 10⁻⁷ Torr.

Subsequently, an oxygen gas at a flow rate of 2,000 sccm was supplied into the plasma processing chamber 202 via the gas inlet 206 provided therein. Next, by adjusting a conductance valve (not shown) provided for the exhaust system (not shown), the inside of the plasma processing chamber 202 was maintained at 3 Torr.

Subsequently, by a microwave electrical source of 2.45 GHz (not shown), an electric power of 3.0 kW was supplied via a slotted endless circular waveguide of the microwave supply unit 209.

Accordingly, plasma was generated in the plasma generating chamber 201. Next, a cycle between continuous discharge for 180 seconds and rest for 120 seconds was repeatedly performed.

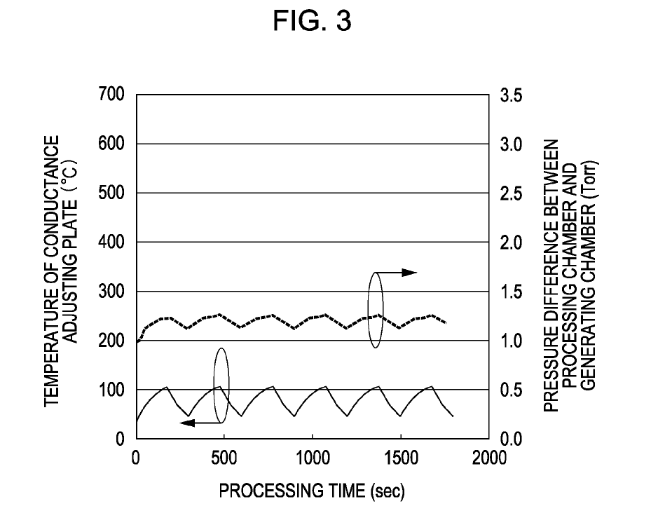

The results obtained by measurement of the central temperature of the conductance adjusting plate 208 and the pressure difference generated between the plasma generating chamber 201 and the plasma processing chamber 202 are shown in FIG. 3.

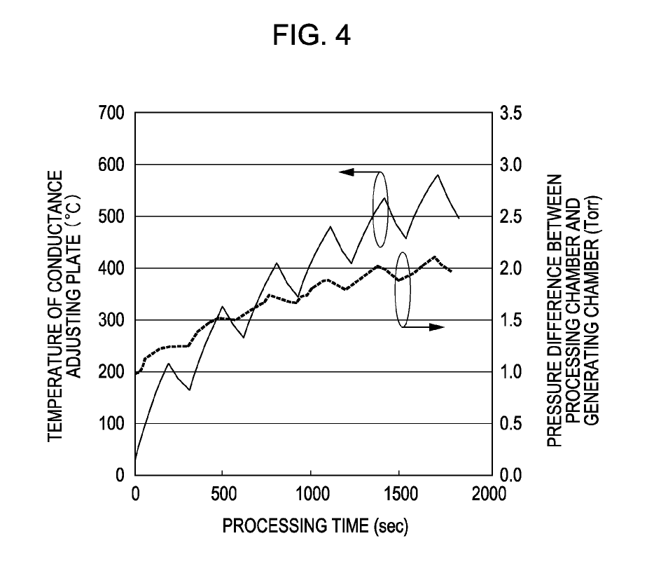

In addition, as a comparative example, quartz having a thermal conductivity of 1.7 W/m·K was used for the conductance adjusting plate 208, discharge was performed under the same conditions as described above, and the pressure difference generated between the plasma generating chamber 201 and the plasma processing chamber 202 was measured. The results thereof are shown in FIG. 4.

As shown in FIG. 4, when the conductance adjusting plate 208 is formed of quartz, the central temperature (represented by the thin line in the figure) of the conductance adjusting plate 208 is increased at each processing cycle, and concomitant with this increase, the pressure difference (represented by the dotted line in the figure) between the plasma generating chamber 201 and the plasma processing chamber 202 is also increased.

On the other hand, as shown in FIG. 3, when the conductance adjusting plate 208 is formed of silicon, although the central temperature (represented by the thin line in the figure) of the conductance adjusting plate 208 is increased during the discharge, cooling is rapidly performed during the rest, and as a result, the central temperature is not continuously increased at each processing cycle.

In addition, as shown in FIG. 3, when the conductance adjusting plate 208 is formed of silicon, the pressure difference (represented by the dotted line in the figure) between the plasma generating chamber 201 and the plasma processing chamber 202 is not continuously increased and has an approximately constant value.

In the second embodiment of the present invention, an up-flow processing method is used in which the process gas is supplied in the plasma processing chamber 202 to introduce the gas flow in the plasma generating chamber 201 and is subsequently discharged from the exhaust outlet 207 provided therein.

Also in this case, since the conductance adjusting plate 208 is formed of a material having a thermal conductivity of at least 30 W/m·K, and the cooling unit 211 is provided in the wall of the processing container which supports the conductance adjusting plate 208, an unnecessary increase in temperature and an unnecessary change in pressure difference can be prevented.

Hence, since the expansion of the conductance adjusting plate 208 can be prevented, and the change in volume flow rate of the process gas passing through the gas holes of the conductance adjusting plate 208 can be prevented, a desired pressure difference can be obtained, and hence advantages of improving process reproducibility and process accuracy in plasma processing can be sufficiently obtained.

### Third Exemplary Embodiment

Hereinafter, a third exemplary embodiment of the present invention will be described. A plasma processing apparatus of the third exemplary embodiment according to the present invention has a similar structure as that of the plasma processing apparatus (microwave plasma processing apparatus) shown in FIG. 2, and the formation of an ultra thin gate oxide film of a semiconductor device will be described by way of example.

As the objective substrate 203, an 8-inch p-type single crystal silicon substrate (plane orientation: <100>, resistivity: 10 Ω·cm) from which a native oxide film on the surface thereof is removed by cleaning is used. Hereinafter, the objective substrate 203 is called a silicon substrate.

Next, a concrete example of the above plasma processing of the third exemplary embodiment according to the present invention will be described. First, after the silicon substrate 203 was placed on the support member 204, the insides of the plasma generating chamber 201 and the plasma processing chamber 202 were exhausted from the exhaust outlet 207 provided in the wall of the plasma generating chamber 201 via an exhaust system (not shown) to a pressure of 10⁻⁷ Torr. Subsequently, electricity was supplied to the temperature control portion (heater) 205 so that the silicon substrate 203 was heated to 280° C. and was then maintained at the same temperature.

An oxygen gas at a flow rate of 500 sccm was supplied from the gas inlet 206 provided in the plasma processing chamber 202. Subsequently, by adjusting a conductance valve (not shown) provided for the exhaust system (not shown), the inside of the plasma processing chamber 202 was maintained at 3 Torr.

Next, an electric power of 3.0 kW was supplied by a microwave electrical source (not shown) of 2.45 GHz to the plasma generating chamber 201 via a slotted endless circular waveguide. Accordingly, plasma was generated in the plasma generating chamber 201.

In this step, the oxygen gas supplied via the gas inlet 206 was excited and decomposed in the plasma generating chamber 201, so that active species, such as O⁺ ions and O radicals, were generated.

Part of the active species flowing by diffusion in a direction against the gas flow passed through the holes of the conductance adjusting plate 208, and as a result, a very small amount of the active species reached the surface of the silicon substrate 203. As described above, an oxidation processing for 180 seconds was continuously performed on the surfaces of 25 silicon substrates 203.

The film thickness uniformity between the silicon substrates 203 was evaluated after the oxidation processing, and the results were superior such that the average oxide film thickness was 1.6 nm, and the film thickness uniformity between the silicon substrates 203 was ±1.0%.

That is, also in the third embodiment of the present invention, since the plasma processing apparatus shown in FIG. 2 is used, the expansion of the conductance adjusting plate 208 and the change in volume flow rate of the process gas can be prevented, and a desired pressure difference is obtained, so that superior film thickness uniformity between the silicon substrates 203 can be obtained.

Accordingly, also in the third embodiment of the present invention, advantages of improving process reproducibility and process accuracy in plasma processing can be sufficiently obtained.

### Fourth Exemplary Embodiment

Next, a fourth exemplary embodiment of the present invention will be described. A plasma processing apparatus of Embodiment 4 according to the present invention has the same structure as that of the plasma processing apparatus (microwave plasma processing apparatus) shown in FIG. 2, and the formation of an ultra thin gate oxynitride film of a semiconductor device will be described by way of example.

As the objective substrate 203, an 8-inch p-type single crystal silicon substrate (plane orientation: <100>, resistivity: 10 Ω·cm) is used on which, after a native oxide film on the surface thereof is removed by cleaning, an oxide film having a thickness of 1.9 nm is grown by a rapid thermal oxidation method. Hereinafter, the objective substrate 203 is called a silicon substrate.

Next, a concrete example of the above plasma processing of the fourth exemplary embodiment according to the present invention will be described. First, after the silicon substrate 203 was placed on the support member 204, the insides of the plasma generating chamber 201 and the plasma processing chamber 202 were exhausted from the exhaust outlet 207 provided in the wall of the plasma generating chamber 201 via an exhaust system (not shown) to a pressure of 10⁻⁷ Torr. Subsequently, electricity was supplied to the temperature control portion (heater) 205 so that the silicon substrate 203 was heated to 280° C. and was then maintained at the same temperature. A nitrogen gas at a flow rate of 100 sccm was supplied from the gas inlet 206 provided in the wall of the plasma processing chamber 202.

Subsequently, by adjusting a conductance valve (not shown) provided for the exhaust system (not shown), the inside of the plasma processing chamber 202 was maintained at 0.5 Torr.

Next, an electric power of 3.0 kW was supplied by a microwave electrical source (not shown) of 2.45 GHz to the plasma generating chamber 201 via a slotted endless circular waveguide. Accordingly, plasma was generated in the plasma generating chamber 201. In this step, the nitrogen gas supplied via the gas inlet 206 was excited and decomposed in the plasma generating chamber 201, so that active species, such as N⁺ ions and N radicals, were generated.

Part of the active species flowing by diffusion in a direction against the gas flow passed through the holes of the conductance adjusting plate 208, and as a result, a very small amount of the active species reached the surface of the silicon substrate 203.

As described above, a nitridation processing for 180 seconds was continuously performed on the surfaces of 25 silicon substrates 203.

The film thickness uniformity between the silicon substrates 203 in terms of an effective oxide thickness (EOT) was evaluated for the oxynitride films after the nitridation processing, and the results were superior such that the average EOT was 1.7 nm, and the uniformity was 1.5%. Also in Embodiment 4 of the present invention, since the plasma processing apparatus shown in FIG. 2 is used, the expansion of the conductance adjusting plate 208 and the change in volume flow rate of the process gas can be prevented, and a desired pressure difference is obtained, so that superior uniformity in terms of the effective oxide thickness between the silicon substrates 203 can be obtained.

Accordingly, also in the fourth exemplary embodiment of the present invention, advantages of improving process reproducibility and process accuracy in plasma processing can be sufficiently obtained.

### Fifth Exemplary Embodiment

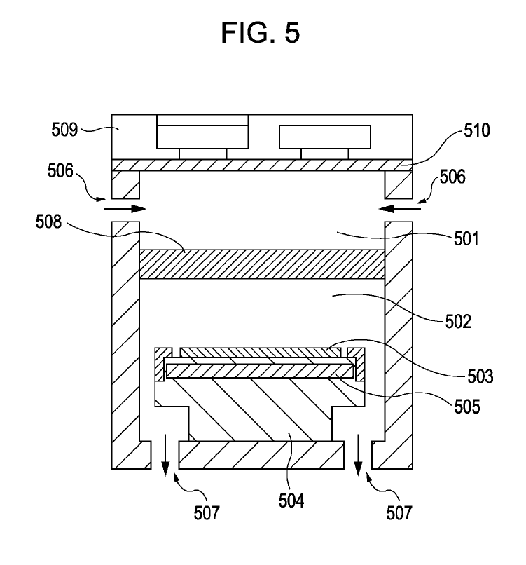

Next, a fifth exemplary embodiment of the present invention will be described. FIG. 5 is a cross-sectional view showing a schematic structure of a plasma processing apparatus (microwave plasma processing apparatus) of the fifth exemplary embodiment according to the present invention.

In the fifth embodiment of the present invention, the plasma processing apparatus shown in FIG. 5 is used, and the formation of an insulating tantalum oxide film used for a capacitor of a semiconductor device will be described by way of example.

As shown in FIG. 5, the plasma processing apparatus has a plasma generating chamber 501, a plasma processing chamber 502, an objective substrate 503, a support member 504, a temperature control portion 505, a gas inlet 506, and an exhaust outlet 507.

In addition, the plasma processing apparatus has a conductance adjusting plate 508, a microwave supply unit 509, and a microwave transmitting unit 510, and performs plasma processing for the objective substrate 503.

Although being not shown in detail in the figure, in the plasma processing apparatus of this embodiment, the microwave generator, the isolator, the impedance matching device, and the like, which are described in Embodiment 1, are provided.

In addition, the plasma processing chamber 502 is a vacuum processing container which receives the objective substrate 503 on a stage on the temperature control portion 505 and which performs plasma processing for the objective substrate 503 under a vacuum or a reduced-pressure condition.

In FIG. 5, a gate valve and the like used for transferring the objective substrate 503 from and to a load lock chamber (not shown) are omitted in the figure. The objective substrate 503 is placed on the stage on the support member 504; however, whenever necessary, the support member 504 may be formed so that the height thereof is adjustable. That is, the support member 504 is placed in the plasma processing chamber 502 and supports the objective substrate 503.

The temperature control portion 505 is formed of a heater or the like and is configured to control the temperature so as to be suitable for processing performed, for example, in the range of 200 to 400° C.

The gas inlet 506 is provided in the wall of the plasma generating chamber 501 and supplies a plasma process gas into the plasma generating chamber 501. The gas inlet 506 is a part of a gas supply unit. Although being not shown in detail in the figure, the gas supply unit has gas supply sources, valves, mass flow controllers, and gas lines connecting therebetween, and supplies a process gas and a discharge gas in order to obtain predetermined plasma by microwave excitation.

In addition, the exhaust outlet 507 is provided in the wall of the plasma processing chamber 502, and although being not shown in detail in the figure, the exhaust outlet 507 forms a pressure regulating mechanism together with a pressure regulating valve, a pressure gauge, a vacuum pump, and a control portion.

The control portion of the pressure regulating mechanism performs pressure regulation by controlling the pressure regulating valve (such as a gate valve provided with a pressure regulating function manufactured by VAT SKK VACUUM LTD. or an exhaust slot valve manufactured by MKS Instrument Inc.) which regulates the pressure of the plasma processing chamber 502 by the degree of opening of the valve.

As a result, through the exhaust outlet 507, the inside pressure of the plasma processing chamber 502 is controlled to a pressure suitable for plasma processing. The pressure is preferably in the range of 13 mPa to 1,330 Pa and more preferably in the range of 665 mPa to 665 Pa.

The conductance adjusting plate 508 is formed of a partition having a plurality of penetrated holes and is provided so as to separate the plasma processing chamber 502 from the plasma generating chamber 501.

For the conductance adjusting plate 508, an AlN ceramic plate having a diameter of 260 mm, a thickness of 15 mm, and a thermal conductivity of 160 W/m·K is used. In this plate, 181 penetrated holes having a diameter of 3 mm are concentrically disposed.

In addition, although being not shown in detail in the figure, in the conductance adjusting plate 508, a water cooling pipe (cooling unit) is embedded through which cooling water maintained at room temperature is circulated, and concomitant with operation of a circulating unit, the temperature is maintained at a predetermined temperature, that is, at a suitable temperature for plasma processing, by circulated cooling water.

Although being not shown in detail in the figure, a water cooling pipe or the like may be embedded as the cooling unit in the wall of the processing container supporting the conductance adjusting plate 508.

As the objective substrate 503, an 8-inch p-type single crystal silicon substrate (plane orientation: <100>, resistivity: 10 Ω·cm) is used. Hereinafter, the objective substrate 503 is called a silicon substrate.

The microwave transmitting unit 510 transmits a microwave supplied from a microwave generator to the plasma generating chamber 501 and also functions as a partition thereof.

The microwave supply unit 509 has, for example, a slotted planar structure and has a function of supplying a microwave to the plasma generating chamber 501 via the microwave transmitting unit 510.

Heretofore, the plasma processing apparatus of Embodiment 5 according to the present invention is briefly described; however, since the remaining structure and the related matters (such as gases used in the embodiment) are the same as those of Embodiment 1, detailed description thereof is omitted.

Next, an example of the above plasma processing of the fifth exemplary embodiment according to the present invention will be described. First, the silicon substrate 503 was placed on the substrate support member 504, and the insides of the plasma processing chamber 502 and the plasma generating chamber 501 were exhausted from the exhaust outlet 507 located at the bottom of the plasma processing chamber 502 to a pressure of 10⁻⁷ Torr via an exhaust system (not shown).

Subsequently, electricity was supplied to the temperature control unit (heater) 505 so that the silicon substrate 503 was heated to 150° C. and was maintained at the same temperature.

An oxygen gas at a flow rate of 1,000 sccm and a tetraethoxy tantalum (TEOT) gas at a flow rate of 50 sccm were supplied to the plasma generating chamber 501 through the gas inlet 506 provided in the wall of the plasma generating chamber 501.

Next, by adjusting a conductance valve (not shown) provided for the exhaust system (not shown), the inside of the plasma processing chamber 502 was maintained at 50 mTorr.

Subsequently, an electric power of 2.0 kW was supplied from a microwave electrical source of 2.45 GHz to the plasma generating chamber 501 via a circular waveguide of the microwave supply unit 509. Accordingly, plasma was generated in the plasma generating chamber 501.

The oxygen gas supplied from the gas inlet 506 was excited and decomposed in the plasma generating chamber 501 into active species, was then transported to the silicon substrate 503 side, and was allowed to react with the TEOT gas; hence, as a result, a tantalum oxide film was formed on the silicon substrate 503.

As described above, a film-forming processing of tantalum oxide was continuously performed for 25 silicon substrates 503. The uniformity in thickness of the tantalum oxide film was evaluated after the processing, and the results were superior such that the average film thickness and the uniformity between the silicon substrates 503 were 5.2 nm and ±1.8%, respectively.

That is, in the case of Embodiment 5 of the present invention, since the plasma processing apparatus shown in FIG. 5 is used, the expansion of the conductance adjusting plate 508 can be prevented, and the change in volume flow rate of the process gas can be prevented; hence, a desired pressure difference can be obtained, and as a result, superior uniformity in thickness of the tantalum oxide film between the silicon substrates 503 can be obtained. Accordingly, also in Embodiment 5 of the present invention, advantages of improving process reproducibility and process accuracy in plasma processing can be sufficiently obtained.

### Sixth Exemplary Embodiment

Next, a sixth exemplary embodiment of the present invention will be described. A plasma processing apparatus of the sixth embodiment according to the present invention has the same structure as that of the plasma processing apparatus (microwave plasma processing apparatus) shown in FIG. 5, and an ashing processing of a semiconductor device will be described by way of example.

As the objective substrate 503, an 8-inch p-type single crystal silicon substrate (plane orientation: <100>, resistivity: 10 Ω·cm) provided with a photoresist having a thickness of 10 μm is used. Hereinafter, the objective substrate 503 is called a silicon substrate.

Next, a concrete example of the above plasma processing of the sixth embodiment according to the present invention will be described. First, after the silicon substrate 503 was placed on the support member 504, the insides of the plasma generating chamber 501 and the plasma processing chamber 502 were exhausted from the exhaust outlet 507 located at the bottom of the plasma processing chamber 502 to a pressure of 10⁻⁷ Torr via an exhaust system (not shown).

Subsequently, electricity was supplied to the temperature control unit (heater) 505 so that the silicon substrate 503 was heated to 300° C. and was maintained at the same temperature.

An oxygen gas at a flow rate of 500 sccm and a CF₄ gas at a flow rate of 10 sccm were supplied into the plasma generating chamber 501 through the gas inlet 506 provided in the wall of the plasma generating chamber 501. Next, by adjusting a conductance valve (not shown) provided for the exhaust system (not shown), the inside of the plasma processing chamber 502 was maintained at 200 mTorr.

Subsequently, an electric power of 3.0 kW was supplied from a microwave electrical source of 2.45 GHz into the plasma generating chamber 501 via a circular waveguide of the microwave supply unit 509. Accordingly, plasma was generated in the plasma generating chamber 501.

The oxygen gas supplied from the gas inlet 506 was excited and decomposed in the plasma generating chamber 501 into active species, was then transported to the silicon substrate 503 side, and was allowed to react with the photoresist; hence, the photoresist was removed by ashing.

As described above, an ashing processing of the photoresist on the surface of the silicon substrate 503 was continuously performed for 25 substrates.

The uniformity in ashing rate was evaluated after the processing, and the results were superior such that the average ashing rate and the uniformity between the silicon substrates 503 were 2.3 μm/min and ±2.6%, respectively.

That is, in the case of the sixth embodiment of the present invention, since the plasma processing apparatus shown in FIG. 5 is used, the expansion of the conductance adjusting plate 508 can be prevented, and the change in volume flow rate of the process gas can be prevented; hence, a desired pressure difference can be obtained, and as a result, superior uniformity in ashing rate can be obtained.

Accordingly, also in Embodiment 6 of the present invention, advantages of improving process reproducibility and process accuracy in plasma processing can be sufficiently obtained.

According to the plasma processing apparatus of the present invention, the conductance adjusting plate is provided so as to separate the plasma processing chamber from the plasma generating chamber, and the process gas passes through the conductance adjusting plate.

In addition, this conductance adjusting plate is formed of a material having a thermal conductivity of at least 30 W/m·K and has a unit configured to maintain a predetermined temperature.

Hence, the temperature of the conductance adjusting plate functioning as a partition between the plasma generating chamber and the plasma processing chamber can be prevented from being increased at each processing. By prevention of the increase in temperature of the conductance adjusting plate, the expansion of the conductance adjusting plate is prevented, and the change in volume flow rate of the process gas, which passes through the gas holes of the conductance adjusting plate, can be prevented.

As a result, a desired pressure difference can be obtained, and process reproducibility and process accuracy in plasma processing can be improved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-200531 filed Jul. 24, 2006, which is hereby incorporated by reference herein in its entirety.

What is claimed is:

1. A plasma processing apparatus comprising:
a generating chamber configured to generate plasma;
a processing chamber configured to receive an objective substrate; and
a conductance adjusting plate configured to allow a process gas to pass therethrough and which is provided so as to separate the generating chamber from the processing chamber;
wherein the generating chamber and the processing chamber form a processing container, and the processing container has a cooling unit configured to cool a portion of the processing container supporting the conductance adjusting plate to maintain the conductance adjusting plate at a predetermined temperature.

2. The plasma processing apparatus according to claim 1, wherein the cooling unit is configured to circulate a cooled cooling medium in the conductance adjusting plate.

3. The plasma processing apparatus according to claim 1, wherein the conductance adjusting plate is formed of silicon.

4. The plasma processing apparatus according to claim 1, wherein the conductance adjusting plate has a plurality of penetrated holes which penetrate therethrough so that the generating chamber and the processing chamber communicate with each other.

5. The plasma processing apparatus according to claim 1, wherein the process gas used for the plasma processing is supplied from the side of the generating chamber in which the plasma is generated, passes through the conductance adjusting plate, flows into the processing chamber in which the objective substrate is received, processes the surface of the objective substrate, and is discharged outside the apparatus.

6. The plasma processing apparatus according to claim 1, wherein the process gas used for the plasma processing is supplied from the side of the processing chamber in which the objective substrate is received, passes through the conductance adjusting plate, flows into the generating chamber in which the plasma is generated, and is discharged outside the apparatus.

7. The plasma processing apparatus according to claim 1, wherein the plasma processing is one of etching, ashing, modification, and thin-film deposition, which is performed at the surface of the objective substrate.

8. The plasma processing apparatus according to claim 7, wherein the modification is an oxidation or a nitridation processing.
